(19) United States
(12) Patent Application Publication
(10) Pub. No.: US 2026/0214767 A1
(43) Pub. Date: Jul. 23, 2026

(54) FEEDBACK CIRCUIT AND CONTROL CIRCUIT FOR LAMP LOAD

(71) Applicant: SAVANT TECHNOLOGIES LLC, East Cleveland, OH (US)

(72) Inventors: Yimin ZHU, Shanghai (CN); Yehui WANG, Shanghai (CN)

(73) Assignee: SAVANT TECHNOLOGIES LLC, East Cleveland, OH (US)

(21) Appl. No.: 19/367,499

(22) Filed: Oct. 23, 2025

(30) Foreign Application Priority Data
Oct. 30, 2024 (CN) 202411533645.1

(51) Int. Cl. H05B 45/40; H05B 45/345; H05B 47/28

(52) U.S. Cl. CPC H05B 45/40; H05B 45/345; H05B 47/28

(57) ABSTRACT

Provided is a feedback circuit and control circuit for a lamp load. The feedback circuit is connected to a drive circuit having a non-dimming chip, a semiconductor switching device and a sampling resistor, the semiconductor switching device has a gate, a source and drain connected to a negative terminal of the lamp load, the sampling resistor is connected between the source and the ground; and the chip includes a first output terminal and a voltage feedback terminal, the first output terminal is connected to the gate and the feedback circuit has a first voltage-dividing resistor and a second voltage-dividing resistor with a first end of the first voltage-dividing resistor connected to the negative terminal, a second end connected to a first end of the second voltage-dividing resistor, and a second end connected to the source and the voltage feedback terminal connected to the second end of the first voltage-dividing resistor.

### CROSS-REFERENCE TO RELATED APPLICATIONS

This application claims priority to Chinese Patent Application Serial Number 202411533645.1, filed October 30, 2024, which is herein incorporated by reference.

### TECHNICAL FIELD

The present application relates to a drive circuit for a lamp load, which comprises a non-dimming chip, and more particularly, relates to a feedback circuit capable of reducing a power difference of a constant-current drive circuit comprising a non-dimming chip under varying operating voltage, and a control circuit for a lamp load, which comprises the feedback circuit.

### BACKGROUND

For a lamp load, when a constant-current drive circuit comprising a non-dimming chip is used, an output current of the circuit cannot be adjusted according to a varying voltage. As a result, under varying alternating-current voltage conditions (such as 108 Vac, 120, Vac and 132 Vac), there will be significant difference in operating powers of the lamp load. Generally, in order to ensure that the drive circuit operates normally under the condition of 132 Vac, an actual operating power thereof under a nominal operating condition of 120 Vac is reduced, which in turn causes a decrease in the power utilization rate of the drive circuit. Using a constant-current drive circuit comprising a dimming chip can solve the power difference issue under varying voltage conditions. However, the use of the dimming chip can significantly increase the circuit cost.

In view of this, there is a need for a low-cost method to reduce power difference of a constant-current drive circuit for a lamp load comprising a non-dimming chip under varying operating voltage.

### SUMMARY OF THE INVENTION

The present application is proposed in view of the described problems, and a main object of the present application is to provide a feedback circuit for a constant-current drive circuit of a lamp load, the drive circuit comprising a non-dimming chip, to solve the technical problem in the prior art that it is difficult to solve, at a low cost, the power difference of the constant-current drive circuit comprising the non-dimming chip under varying operating voltage, thereby reducing the power difference of the drive circuit under varying input voltage in a low-cost and simple manner, increasing the power utilization rate of the drive circuit for a lamp load, and reducing the overall power consumption and temperature rise of the circuit.

In order to achieve the described object, according to one aspect of the present application, provided is a feedback circuit for a lamp load, connected to a drive circuit for the lamp load, the drive circuit comprising a non-dimming chip, a semiconductor switching device and a sampling resistor, the semiconductor switching device comprising a gate, a source and a drain; wherein the drain of the semiconductor switching device is connected to a negative terminal of the lamp load, the sampling resistor is connected between the source of the semiconductor switching device and the ground, and the non-dimming chip comprises a first output terminal and a voltage feedback terminal, the first output terminal is connected to the gate of the semiconductor switching device; wherein the feedback circuit comprises: a first voltage-dividing resistor and a second voltage-dividing resistor connected in series, wherein a first end of the first voltage-dividing resistor is connected to the negative terminal of the lamp load, a second end of the first voltage-dividing resistor is connected to a first end of the second voltage-dividing resistor, and a second end of the second voltage-dividing resistor is connected to the source of the semiconductor switching device; wherein the voltage feedback terminal is connected to the second end of the first voltage-dividing resistor.

In this way, as an input voltage of a power input terminal increases, a voltage drop across the second voltage-dividing resistor increases, such that a voltage drop across the sampling resistor decreases, resulting in a decrease in the current flowing through the lamp load, the semiconductor switching device, and the sampling resistor, and thus when the input voltage fluctuates, the circuit power difference caused by varying input voltage is reduced, such that the circuit power consumption under varying input voltage remains stable, and the overall power consumption and temperature rise of the circuit are reduced.

Further, according to one embodiment of the present application, the non-dimming chip further comprises a first input terminal and a grounding terminal, wherein the first input terminal is connected to the power input terminal; the drive circuit further comprises a first capacitor and a second capacitor, wherein the first capacitor is connected in parallel with the lamp load, and two ends of the second capacitor are respectively connected to the first input terminal and the grounding terminal.

In this way, the non-dimming chip and the semiconductor switching device can maintain a sum of the voltage drop across the sampling resistor and the voltage drop across the second voltage-dividing resistor at a preset fixed voltage threshold, such that the current flowing through the sampling resistor can decrease along with the increase of the input voltage.

Further, according to one embodiment of the present application, the semiconductor switching device is a metal oxide semiconductor field-effect transistor.

In this way, the conduction degree of the semiconductor switching device can be adjusted according to the difference between a sampling voltage and a preset threshold voltage, and then the magnitude of the current flowing through the sampling resistor can be adjusted.

Further, according to one embodiment of the present application, each of the first voltage-dividing resistor and the second voltage-dividing resistor is composed of one or more resistors.

In this way, resistors with fixed resistance values can be flexibly combined to achieve the first voltage-dividing resistor and the second voltage-dividing resistor with desired resistance values.

Further, according to one embodiment of the present application, a voltage comparator and a control circuit are provided within the non-dimming chip, wherein the voltage comparator is configured to compare a sampling voltage inputted from the voltage feedback terminal with a preset threshold voltage and output a comparison result, and the control loop is configured to adjust the voltage at the first output terminal by using the comparison result.

According to another aspect of the present application, provided is a feedback circuit for a lamp load, connected to a drive circuit for the lamp load, the drive circuit comprising a non-dimming chip, a semiconductor switching device and a sampling resistor, the semiconductor switching device comprising a gate, a source and a drain; the drain of the semiconductor switching device is connected to a negative terminal of the lamp load, and a positive terminal of the lamp load is connected to a power input terminal; the sampling resistor is connected between the source of the semiconductor switching device and the ground; and the non-dimming chip comprises a first output terminal and a voltage feedback terminal, the first output terminal is connected to the gate of the semiconductor switching device, wherein the feedback circuit comprises: a first voltage-dividing resistor and a second voltage-dividing resistor, wherein a first end of the first voltage-dividing resistor is connected to the power input terminal, a second end of the first voltage-dividing resistor is connected to the positive terminal of the lamp load, and a first end of the second voltage-dividing resistor is connected to the drain of the semiconductor switching device, and a second end of the second voltage-dividing resistor is connected to the source of the semiconductor switching device; wherein the voltage feedback terminal is connected to the second end of the first voltage-dividing resistor.

In this way, as an input voltage at the power input terminal increases, a voltage drop across the second voltage-dividing resistor increases, such that a voltage drop across the sampling resistor decreases, resulting in a decrease in the current flowing through the lamp load, the semiconductor switching device, and the sampling resistor, and thus when the input voltage fluctuates, the circuit power difference caused by varying input voltage is reduced, such that the circuit power consumption under varying input voltage remains stable, and the overall power consumption and temperature rise of the circuit are reduced.

Further, according to one embodiment of the present application, the non-dimming chip further comprises a first input terminal and a grounding terminal, wherein the first input terminal is connected to the power input terminal; the drive circuit further comprises a first capacitor and a second capacitor, wherein the first capacitor is connected in parallel with the lamp load, and two ends of the second capacitor are respectively connected to the first input terminal and the grounding terminal.

According to still another aspect of the present application, provided is a control circuit for a lamp load, comprising: the feedback circuit for a lamp load as described above; and a drive circuit for a lamp load, the drive circuit being connected to the feedback circuit.

Embodiments of the present application provide a feedback circuit for a lamp load, connected to a drive circuit for the lamp load, the drive circuit comprising a non-dimming chip, a semiconductor switching device and a sampling resistor, the semiconductor switching device comprising a gate, a source and a drain; wherein the drain of the semiconductor switching device is connected to a negative terminal of the lamp load, the sampling resistor is connected between the source of the semiconductor switching device and the ground, and the non-dimming chip comprises a first output terminal and a voltage feedback terminal, the first output terminal is connected to the gate of the semiconductor switching device; wherein the feedback circuit comprises: a first voltage-dividing resistor and a second voltage-dividing resistor connected in series, wherein a first end of the first voltage-dividing resistor is connected to the negative terminal of the lamp load, a second end of the first voltage-dividing resistor is connected to a first end of the second voltage-dividing resistor, and a second end of the second voltage-dividing resistor is connected to the source of the semiconductor switching device; wherein the voltage feedback terminal is connected to a second end of the first voltage-dividing resistor, so as to at least solve the technical problem in the prior art that it is difficult to solve, at a low cost, the power difference of the constant-current drive circuit comprising a non-dimming chip under varying operating voltage, thereby achieving the technical effects of reducing the power difference of the drive circuit under varying input voltage in a low-cost and simple manner, increasing the power utilization rate of the drive circuit for a lamp load, and reducing the overall power consumption and temperature rise of the circuit.

### BRIEF DESCRIPTION OF THE DRAWINGS

The drawings accompanying the description and constituting a part of the present application are used for providing further understanding of the present application, and the illustrative embodiments of the present application and illustrations thereof are used to explain the present application, rather than constitute inappropriate limitation on the present application. In the drawings:

FIG. 1 is a schematic diagram of a conventional constant-current drive circuit for a lamp load, which comprises a non-dimming chip;

FIG. 2 is a schematic diagram showing an input voltage and current over time in the constant-current drive circuit, as illustrated in FIG. 1;

FIG. 3 is a schematic diagram of a feedback circuit for a lamp load and a control circuit comprising the feedback circuit according to a first embodiment of the present application;

FIG. 4 is a schematic diagram showing an input voltage and current over time in the control circuit for a lamp load, as illustrated in FIG. 3;

FIG. 5 is a schematic diagram of a feedback circuit for a lamp load and a control circuit comprising the feedback circuit according to a first exemplary embodiment of the present application;

FIG. 6 shows measurement results of voltage waveforms at various nodes of the control circuit in the case of the control circuit illustrated in FIG. 5;

FIG. 7 shows actual measurement results of circuit power consumption in the case of the constant-current drive circuit illustrated in FIG. 1 and actual measurement results of circuit power consumption in the case of the control circuit illustrated in FIG. 5; and

FIG. 8 is a schematic diagram of a feedback circuit for a lamp load and a control circuit comprising the feedback circuit according to a second embodiment of the present application.

### DETAILED DESCRIPTION

It is to be noted that embodiments in the present application and features in the embodiments may be combined with one another without conflicts. Hereinafter, the present application is described in detail with reference to the accompanying drawings and in conjunction with the embodiments.

It is to be noted that unless otherwise indicated, all technical and scientific terms used in the present application have the same meanings as those commonly understood by a person of ordinary skill in the art to which the present application belongs.

In the present application, unless specified to the contrary, directional terms such as "upper, lower, top and bottom" are generally used regarding the directions shown in the figures, or for the components themselves in vertical, perpendicular or gravity directions; likewise, for ease of understanding and description, "internal, external" refer to internal and external relative to the outline of each component itself, but the described directional terms are not used to limit the present application.

First, a conventional constant-current drive circuit 100' for a lamp load, which comprises a non-dimming chip, will be described with reference to FIGS. 1 and 2. As illustrated in FIG. 1, the conventional constant-current drive circuit 100' comprises a non-dimming chip 110, a semiconductor switching device (e.g. MOS transistor) 120, and a sampling resistor 130. A drain of the semiconductor switching device 120 is connected to a negative terminal of a lamp load 200 (e.g. one or more LEDs), and the sampling resistor 130 is connected between a source of the semiconductor switching device 120 and ground. The non-dimming chip 110 comprises a first output terminal 1101 and a voltage feedback terminal 1102, wherein the first output terminal 1101 is connected to a gate of the semiconductor switching device 120, and the voltage feedback terminal 1102 is connected to a line connecting the sampling resistor 130 and the source of the semiconductor switching device 120. In addition, a positive terminal of the lamp load 200 is also connected to a power input terminal (for example, via a rectifier and a driver), the lamp load 200 is also connected in parallel to a first capacitor 140, and two ends of a second capacitor 150 are respectively connected to a first input terminal 1103 and a grounding terminal 1104 of the non-dimming chip 110.

In the constant-current drive circuit 100', when an input voltage Vin at the power input terminal is greater than a forward voltage VF of the lamp load, the first input terminal 1103 of the non-dimming chip 110 is connected to the power input terminal through voltage divider resistors (as illustrated in R3 and R4 in the figure). The non-dimming chip 110 controls the voltage at the first output terminal 1101 according to the voltage at the first input terminal 1103, and therefore the first output terminal 1101 is continuously controlled at a high level, and the semiconductor switching device 120 is turned on. At this time, the voltage at the positive terminal of the lamp load 200 is greater than the voltage at the negative terminal, and the lamp load 200 is turned on. At this time, a drive current of the lamp load 200 is controlled by the sampling resistor 130 (the non-dimming chip 110 compares a sampling voltage at the voltage feedback terminal 1102 with a predetermined threshold voltage, and controls the conduction degree of the semiconductor switching device 120 according to a voltage difference between the sampling voltage and the predetermined threshold voltage, such that the voltage at the voltage feedback terminal 1102 approaches the predetermined threshold voltage, wherein the threshold voltage to be compared with the sampling voltage of the voltage feedback terminal 1102 is, for example, 0.2 V, and the resistance value of the sampling resistor 130 is fixed). In addition, when the input voltage Vin at the power input terminal is less than the forward voltage VF of the lamp load, the non-dimming chip may continue to operate due to freewheeling of the second capacitor 150, and thus the first output terminal 1101 is still at a high level, such that the semiconductor switching device 120 is turned on. At this time, since the input voltage is not sufficient to support conduction of the lamp load 200, the first capacitor 140 supplies a freewheeling operating voltage to the lamp load 200. In the constant-current drive circuit 100', since the conduction degree of the semiconductor switching device 120 is affected by the difference between the sampling voltage of the voltage feedback terminal 1102 and the threshold voltage, and the result thereof is that the conduction degree of the semiconductor switching device 120 (i.e. the current flowing therethrough and the sampling resistor 130) is controlled such that the voltage drop across the sampling resistor 130 (i.e., the sampling voltage at the voltage feedback terminal 1102) approaches the threshold voltage. That is, the current flowing through the semiconductor switching device 120 and the sampling resistor 130 cannot be adjusted according to changes in the input voltage. In particular, when alternating-current input voltage is 108 Vac, 120 Vac, and 132 Vac, the operating powers of the circuit under different alternating-current voltage conditions differ greatly, as illustrated in FIG. 2. This is because the forward voltage VF of the lamp load is fixed. Therefore, compared with the condition of 108 Vac, the lamp load 200 is turned on earlier and turned off later in the condition of 132 Vac, which results in a larger conduction angle of the lamp load 200. Additionally, as the operating voltage at 132 Vac is higher, the lamp load 200 will produce higher power at the same current. In order to ensure that the constant-current drive circuit 100' can normally operate under the condition of 132 Vac, generally, an actual operating power thereof under a nominal operating condition of 120 Vac is reduced, which in turn causes a decrease in the power utilization rate of the drive circuit 100'.

The present application aims to solve the described problem existing in the conventional constant-current drive circuit comprising a non-dimming chip. An object of the present application is to provide a feedback circuit for a lamp load, a control circuit comprising same, and a lamp comprising the control circuit, which can reduce the power difference of a drive circuit for a lamp load under varying operating voltage in a low-cost and simple manner. Next, a feedback circuit for a lamp load according to a first embodiment of the present application and a control circuit comprising the feedback circuit are described with reference to FIGS. 3 to 7.

FIG. 3 is a schematic diagram of a feedback circuit 300 for a lamp load and a control circuit 400 comprising same according to a first embodiment of the present application; and FIG. 4 is a schematic diagram showing an input voltage and current over time in the control circuit for a lamp load as illustrated in FIG. 3. As illustrated in FIG. 3, the feedback circuit 300 for a lamp load 200 according to the first embodiment of the present application may be connected to a drive circuit 100 for the lamp load 200, and the control circuit 400 for the lamp load 200 according to the embodiment of the present application may comprise the feedback circuit 300 and the drive circuit 100. The drive circuit 100 may comprise a non-dimming chip 110, a semiconductor switching device 120 and a sampling resistor 130; the semiconductor switching device 120 may comprise a gate 120G, a source 120S and a drain 120D; the drain 120D of the semiconductor switching device 120 may be connected to a negative terminal of the lamp load 200, and a positive terminal of the lamp load 200 may be connected to a power input terminal; the sampling resistor 130 may be connected between the source 120S of the semiconductor switching device 120 and the ground; and the non-dimming chip 110 may comprise a first output terminal 1101 and a voltage feedback terminal 1102, the first output terminal 1101 may be connected to the gate 120G of the semiconductor switching device 120. The feedback circuit 300 may comprise: a first voltage-dividing resistor 310 and a second voltage-dividing resistor 320 connected in series; wherein a first end of the first voltage-dividing resistor 310 may be connected to the negative terminal of the lamp load 200, a second end of the first voltage-dividing resistor 310 may be connected to a first end of the second voltage-dividing resistor 320, and a second end of the second voltage-dividing resistor 320 may be connected to the source of the semiconductor switching device 120 and a non-grounding end of the sampling resistor 130; wherein the voltage feedback terminal 1102 of the non-dimming chip 110 may be connected to the second end of the first voltage-dividing resistor 310.

In this way, through adding the feedback circuit 300, and changing the connection position (i.e. voltage sampling position) of the voltage feedback terminal 1102 of the non-dimming chip 110 so that it connects to the line connecting the first voltage-dividing resistor 310 and the second voltage-dividing resistor 320, the voltage feedback terminal 1102 may sample a sum of a voltage drop V_130 across the sampling resistor 130 and a voltage drop V_320 across the second voltage-dividing resistor 320, rather than the voltage drop V_130 across the sampling resistor 130 in the conventional techniques.

In the present application, the non-dimming chip 110 is configured to compare a sampling voltage Vsa inputted from the voltage feedback terminal 1102 with a preset threshold voltage Vth (which is a preset value, for example, 0.6 V), and adjust a voltage at the first output terminal 1101 by using the comparison result, so as to control the conduction degree of the semiconductor switching device 120. The conduction degree of the semiconductor switching device 120 affects a current I flowing through a loop composed of the lamp load, the semiconductor switching device itself and the sampling resistor 130, and the conduction degree of the semiconductor switching device 120 is adjusted according to the difference between the sampling voltage Vsa and the preset threshold voltage Vth. Therefore, the result of the control is: the sampling voltage Vsa at the voltage feedback terminal 1102 may be equal to the preset threshold voltage Vth, that is, the resistance value of the sampling resistor R_130*I+V_320 = the threshold voltage Vth. In the present application, the threshold voltage Vth may be a fixed value preset as needed.

In the example illustrated in FIG. 3, when an input voltage Vin (which is an alternating-current voltage) at the power input terminal is greater than a forward voltage VF of the lamp load 200, the lamp load 200 is turned on, and the voltage at the negative terminal of the lamp load 200 varies with the waveform variation of the input voltage Vin. The voltage at the negative terminal of the lamp load 200 may be divided by the first voltage-dividing resistor 310, the second voltage-dividing resistor 320, and the sampling resistor 130.

During power supply, an actual input voltage at the power input terminal may fluctuate within a certain range above or below a nominal value, for example, in the case of an alternating-current voltage of nominal 120 V for the lamp load, the actual inputted alternating-current voltage may fluctuate between 108 V and 132 V. Therefore, when the input voltage Vin increases, the voltage shared by the first voltage-dividing resistor 310 and the second voltage-dividing resistor 320 will increase. Due to the limitation of R_130*I+V_320 = Vth, this causes a decrease in the voltage shared by the sampling resistor 130, and thus the current I flowing through the lamp load 200, the semiconductor switching device 120, and the sampling resistor 130 decreases, as illustrated in FIG. 4. Here, considering that the resistance values of the voltage-dividing resistors 310 and 320 are much greater than the resistance value of the sampling resistor 130, the current flowing through the first voltage-dividing resistor 310 and the second voltage-dividing resistor 320 can be ignored. Since the current I is decreased, the power consumption of the drive circuit 100 remains substantially unchanged even if the input voltage Vin increases. Correspondingly, when the input voltage Vin is decreased, the voltage shared by the first voltage-dividing resistor 310 and the second voltage-dividing resistor 320 are decreased, such that the voltage shared by the sampling resistor 130 is increased; therefore, the current I flowing through the loop composed of the lamp load 200, the semiconductor switching device 120 and the sampling resistor 130 is also increased, and thus the power consumption of the drive circuit 100 also remains substantially unchanged.

Thus, by using the feedback circuit 300 for the lamp load 200, when the input voltage Vin fluctuates, the circuit power difference caused by varying input voltage can be reduced through feedback control, such that the circuit power consumption under varying input voltage remains stable, thereby reducing the overall power consumption and temperature rise of the drive circuit compared with a conventional drive circuit. Furthermore, it is unnecessary to decrease the actual operating power of the circuit under the nominal operating condition of 120 Vac so as to ensure that the circuit operates normally under the condition of 132 Vac like that in the traditional method, thereby increasing the power utilization rate of the drive circuit 100 for a lamp load. In addition, the feedback circuit 300 for the lamp load 200 may be only composed of two voltage-dividing resistors; therefore, the cost is low and the circuit connection structure is simple, thereby achieving the effect of reducing the power difference of the drive circuit 100 under varying input voltage in a low-cost and simple manner.

FIG. 5 is a schematic diagram of a feedback circuit for a lamp load and a control circuit comprising the feedback circuit according to a first exemplary embodiment of the present application. FIG. 5 shows an exemplary embodiment of the control circuit 400 as illustrated in FIG. 3. As illustrated in FIG. 5, the non-dimming chip 110 can further comprise a first input terminal 1103 and a grounding terminal 1104, wherein the first input terminal 1103 may be connected to the power input terminal, and the grounding terminal 1104 may be connected to the ground. The drive circuit 100 can further comprise a first capacitor 140 and a second capacitor 150, wherein the first capacitor 140 may be connected in parallel to the lamp load 200, and the first capacitor 140 may also be connected in parallel to one resistor (represented by R2 in the figure), thereby forming a charging and discharging loop. Both ends of the second capacitor 150 may be connected to the first input terminal 1103 and the grounding terminal 1104 of the non-dimming chip 110, respectively. The voltage at the first output terminal 1101 of the non-dimming chip 110 is also positively correlated with the input voltage at the first input terminal 1103. Therefore, when the input voltage Vin at the power input terminal is a high level, the voltage supplied from the first output terminal 1101 to the gate 120G of the semiconductor switching device 120 is also a high level, the semiconductor switching device 120 can be turned on, and the conduction degree is adjusted according to the difference between the sampling voltage Vsa and the preset threshold voltage Vth. In the present application, the first capacitor 140 and the second capacitor 150 may be electrolytic capacitors.

Further, a voltage comparator and a control circuit (which are not shown) may be provided within the non-dimming chip 110, wherein the voltage comparator may be connected to the voltage feedback terminal 1102 and may be configured to compare the sampling voltage Vsa inputted from the voltage feedback terminal 1102 with the threshold voltage Vth and output a comparison result. The control loop may be configured to adjust the voltage at the first output terminal 1101 by using the comparison result. The voltage comparator and the control loop having the described functions are well known to a person skilled in the art, and therefore will not be repeated herein.

Further, each of the first voltage-dividing resistor 310 and the second voltage-dividing resistor 320 may be composed of one or more resistors. The resistance values of the first voltage-dividing resistor 310 and the second voltage-dividing resistor 320 may be adjusted according to the resistance value of the sampling resistor 130, the input voltage, the forward voltage of the lamp load 200, expected circuit power consumption, etc. Preferably, the resistance value of the first voltage-dividing resistor 310 is far greater than that of the second voltage-dividing resistor 320, and the resistance value of the second voltage-dividing resistor 320 is far greater than that of the sampling resistor 130.

In the present application, the semiconductor switching device 120 may comprise any one of a metal oxide semiconductor field-effect transistor (MOS transistor), a bipolar transistor, a gate bipolar transistor, and a static induction transistor, etc. In the example of FIG. 5, the semiconductor switching device 120 is shown as an N-type MOS transistor, but the present application is not limited thereto.

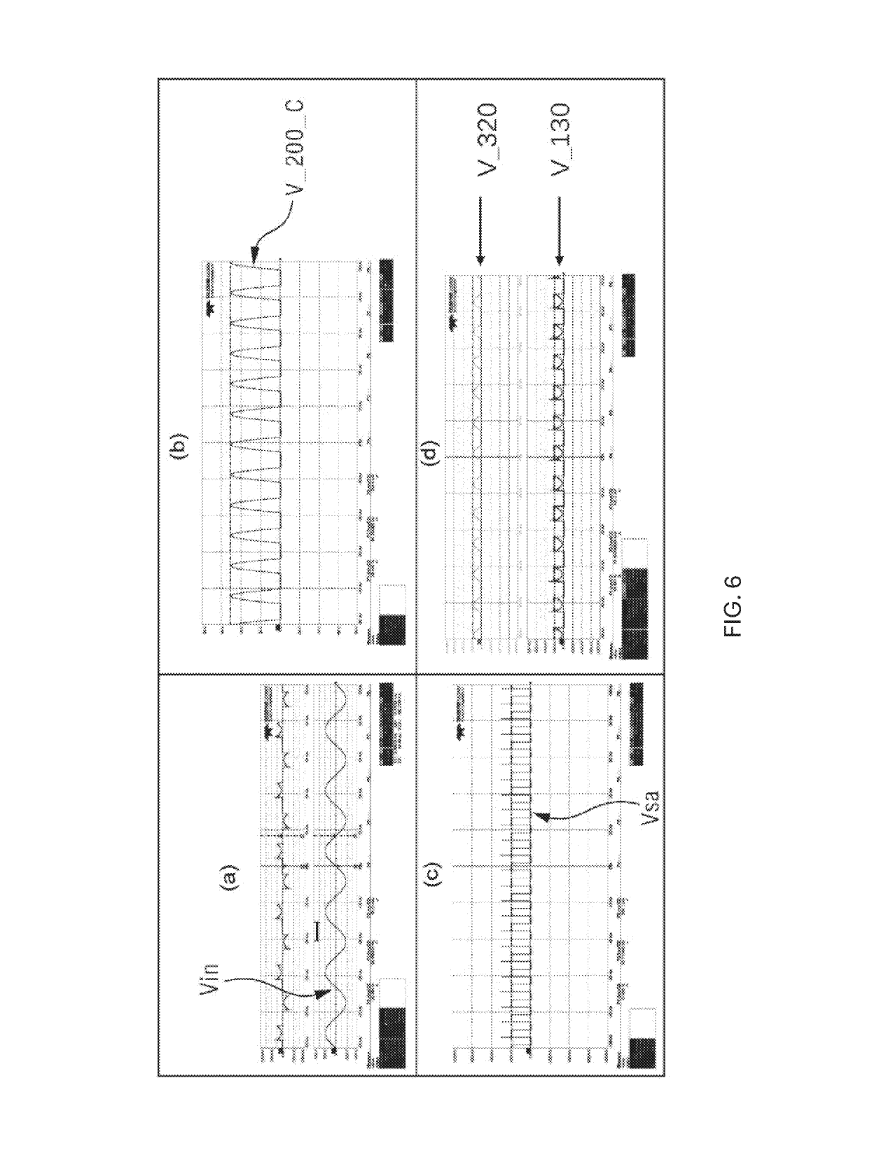

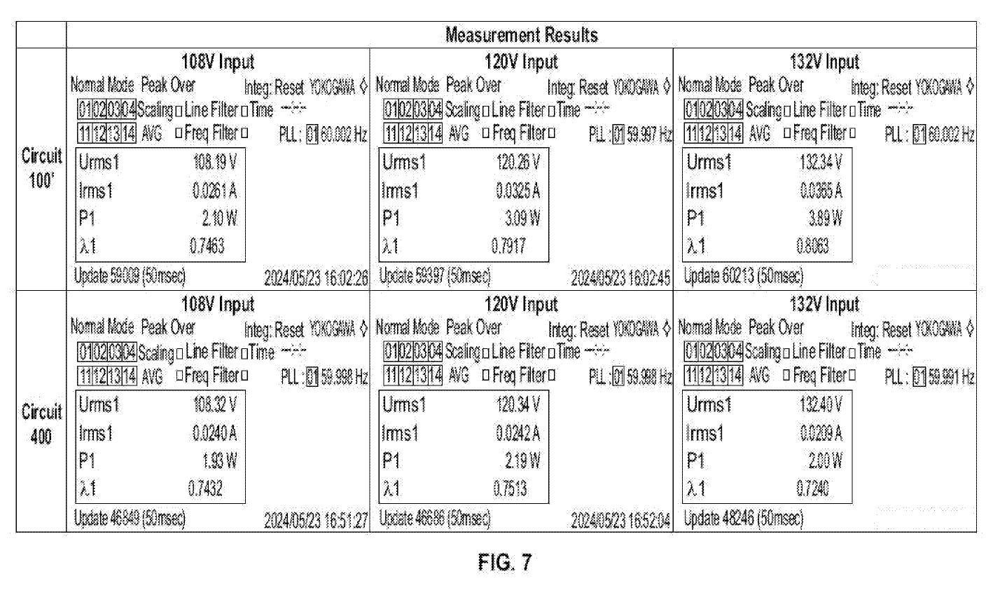

Next, actual measurement results of the voltage waveforms and the circuit power consumptions of various nodes in the control circuit 400 in the case of the feedback circuit 300 and the control circuit 400 illustrated in FIG. 5 will be described with reference to FIGS. 6 and 7. FIG. 6 shows measurement results of voltage waveforms at various nodes of the control circuit illustrated in FIG. 5. During measurement, the resistance value of the sampling resistor 130 is about 6 Ω, the resistance value of the first voltage-dividing resistor 310 is about 500 KΩ, the resistance value of the second voltage-dividing resistor 320 is about 0.75 KΩ, the forward voltage of the lamp load 200 is about 70 V, the input voltage at the power input terminal is about 200 V, and the threshold voltage Vth is about 0.2 V.

As illustrated in FIG. 6, (a) of FIG. 6 shows a waveform of the input voltage Vin at the power input terminal, (b) of FIG. 6 shows a waveform of the voltage V_200_C at the negative terminal of the lamp load 200, (c) of FIG. 6 shows a waveform of the sampling voltage Vsa at the voltage feedback terminal 1102 of the non-dimming chip 110, and (d) of FIG. 6 shows a waveform of a voltage drop V_320 across the second voltage-dividing resistor 320 and a waveform of a voltage drop V_130 across the sampling resistor 130. As seen from FIG. 6, in this circuit, the sampling voltage Vsa at the voltage feedback terminal 1102 is substantially stable at the set threshold voltage Vth.

FIG. 7 shows actual measurement results of circuit power consumption in the case of the constant-current drive circuit illustrated in FIG. 1 and actual measurement results of circuit power consumption in the case of the control circuit illustrated in FIG. 5. The lower part of FIG. 7 shows a measurement result (Urms1) of the input voltage Vin, a measurement result (Irms1) of a current I flowing through the sampling resistor 130, and a measurement result (P1) of power consumed by the circuit in the case of the control circuit 400 illustrated in FIG. 5. As can be determined, as the input voltage increases from 120V to 132V, the current decreases, making the power consumed by the circuit steady around 2 W.

In contrast, the upper part of FIG. 7 shows a measurement result (Urms1) of the input voltage Vin, a measurement result (Irms1) of a current I flowing through the sampling resistor 130, and a measurement result (P1) of power consumed by the circuit in the case of the conventional constant-current drive circuit 100' illustrated in FIG. 1. As can be determined, in the case of the conventional constant-current drive circuit 100', as the input voltage increases, the power consumed by the circuit increases significantly.

FIG. 8 is a schematic diagram of a feedback circuit 300'' for a lamp load and a control circuit 400'' comprising same according to a second embodiment of the present application. In the first embodiment of the present application, the voltage feedback terminal 1102 of the non-dimming chip 110 samples the remaining voltage of the input voltage after it passes through the lamp load 200; however, in the second embodiment of the present application, the voltage feedback terminal 1102 of the non-dimming chip 110 samples the input voltage before it passes through the lamp load 200.

As illustrated in FIG. 8, in the second embodiment of the present application, a drive circuit 100'' of a lamp load 200 may comprise a non-dimming chip 110, a semiconductor switching device 120 and a sampling resistor 130, the semiconductor switching device 120 may comprise a gate 120G, a source 120S and a drain 120D; the drain 120D of the semiconductor switching device 120 may be connected to a negative terminal of the lamp load 200, the sampling resistor 130 may be connected between the source 120S of the semiconductor switching device 120 and the ground; and the non-dimming chip 110 may comprise a first output terminal 1101 and a voltage feedback terminal 1102, the first output terminal 1101 may be connected to the gate 120G of the semiconductor switching device 120. The feedback circuit 300'' for the lamp load 200 according to the second embodiment of the present application may comprise a first voltage-dividing resistor 310 and a second voltage-dividing resistor 320; a first end of the first voltage-dividing resistor 310 may be connected to a power input terminal, and a second end of the first voltage-dividing resistor 310 may be connected to a positive terminal of the lamp load 200, and a first end of the second voltage-dividing resistor 320 may be connected to the drain 120D of the semiconductor switching device 120, and a second end of the second voltage-dividing resistor 320 may be connected to the source 120S of the semiconductor switching device 120; wherein the voltage feedback terminal 1102 of the non-dimming chip 110 may be connected to the second end of the first voltage-dividing resistor 310.

In this way, the voltage sampled by the voltage feedback terminal 1102 is a sum of a voltage drop V_200 across the lamp load 200, a voltage drop V_320 across the second voltage-dividing resistor 320, and a voltage drop V_130 across the sampling resistor 130 (which is equal to the current I multiplied by the resistance R_130). By setting an appropriate threshold voltage Vth', when the input voltage Vin is greater than the forward voltage of the lamp load 200, the result after feedback control is: V_200 + V_320 + I x R_130 = Vth'. Similar to the first embodiment, as the input voltage Vin increases, the voltage drop V_320 across the second voltage-dividing resistor 320 increases, and thus the voltage drop V_130 across the sampling resistor 130 decreases, resulting in a decrease in the current I flowing through the lamp load 200, the semiconductor switching device 120 and the sampling resistor 130. As the current I decreases, the power consumption of the drive circuit 100'' remains substantially unchanged.

Thus, according to the feedback circuit 300'' in the second embodiment, also, when the input voltage Vin fluctuates, the circuit power difference caused by varying input voltage can be reduced, such that the circuit power consumption under varying input voltage remains stable, thereby reducing the overall power consumption and temperature rise of the circuit.

The present application can further provide a lamp, the lamp comprising the control circuit 400 or 400'' as described with reference to FIG. 3 to FIG. 8 according to the present application and the lamp load 200. The lamp can also reduce the circuit power difference caused by varying input voltage when the input voltage at the power input terminal of the lamp fluctuates, such that the circuit power consumption under varying input voltage remains stable, thereby reducing the overall power consumption and temperature rise of the circuit.

It should be noted that the terms used herein are for the purpose of describing specific embodiments only and are not intended to limit exemplary embodiments according to the present application. As used herein, the singular form is intended to comprise the plural form as well, unless the context clearly indicates otherwise, and further it should be understood that the terms "comprises" and/or "comprising" when used in the present description, specify the presence of features, steps, operations, devices, components and/or combinations thereof.

It should be noted that the terms "first", "second" etc., in the description, claims, and accompanying drawings of the present application are used to distinguish similar objects, and are not necessarily used to describe a specific sequence or order. It should be understood that the data so used may be interchanged where appropriate, so that the embodiments of the present disclosure described herein can be implemented in sequences other than those illustrated or described herein.

The content above merely relates to preferred embodiments of the present application and is not intended to limit the present application. For a person skilled in the art, the present application may have various modifications and variations. Any modifications, equivalent replacements, improvements, etc. made within the spirit and principle of the present application shall all belong to the scope of protection of the present application.

1. A feedback circuit for a lamp load, connected to a drive circuit for the lamp load, the drive circuit comprising a non-dimming chip, a semiconductor switching device and a sampling resistor, the semiconductor switching device comprising a gate, a source and a drain; wherein the drain of the semiconductor switching device is connected to a negative terminal of the lamp load, the sampling resistor is connected between the source of the semiconductor switching device and the ground, and the non-dimming chip comprises a first output terminal and a voltage feedback terminal, the first output terminal is connected to the gate of the semiconductor switching device; wherein the feedback circuit comprises:
a first voltage-dividing resistor and a second voltage-dividing resistor connected in series, wherein a first end of the first voltage-dividing resistor is connected to the negative terminal of the lamp load, a second end of the first voltage-dividing resistor is connected to a first end of the second voltage-dividing resistor, and a second end of the second voltage-dividing resistor is connected to the source of the semiconductor switching device,
wherein the voltage feedback terminal is connected to the second end of the first voltage-dividing resistor.

2. The feedback circuit for a lamp load according to claim 1, wherein
the non-dimming chip further comprises a first input terminal and a grounding terminal, wherein the first input terminal is connected to a power input terminal,
the drive circuit further comprises a first capacitor and a second capacitor, wherein the first capacitor is connected in parallel with the lamp load, and two ends of the second capacitor are respectively connected to the first input terminal and the grounding terminal.

3. The feedback circuit for a lamp load according to claim 1, wherein the semiconductor switching device is a metal oxide semiconductor field-effect transistor.

4. The feedback circuit for a lamp load according to claim 1, wherein each of the first voltage-dividing resistor and the second voltage-dividing resistor is composed of one or more resistors.

5. The feedback circuit for a lamp load according to claim 1, wherein a voltage comparator and a control circuit are provided within the non-dimming chip, wherein the voltage comparator is configured to compare a sampling voltage inputted from the voltage feedback terminal with a preset threshold voltage and output a comparison result, and the control loop is configured to adjust the voltage at the first output terminal by using the comparison result.

6. A control circuit for a lamp load, comprising:
the feedback circuit for a lamp load according to claim 1; and
a drive circuit for a lamp load, the drive circuit being connected to the feedback circuit.

7. A feedback circuit for a lamp load, connected to a drive circuit of the lamp load, the drive circuit comprising a non-dimming chip, a semiconductor switching device and a sampling resistor, the semiconductor switching device comprising a gate, a source and a drain; the drain of the semiconductor switching device is connected to a negative terminal of the lamp load, and a positive terminal of the lamp load is connected to a power input terminal; the sampling resistor is connected between the source of the semiconductor switching device and the ground; and the non-dimming chip comprises a first output terminal and a voltage feedback terminal, the first output terminal is connected to the gate of the semiconductor switching device, wherein the feedback circuit comprises:
a first voltage-dividing resistor and a second voltage-dividing resistor, wherein a first end of the first voltage-dividing resistor is connected to the power input terminal, a second end of the first voltage-dividing resistor is connected to the positive terminal of the lamp load, and a first end of the second voltage-dividing resistor is connected to the drain of the semiconductor switching device, and a second end of the second voltage-dividing resistor is connected to the source of the semiconductor switching device,
wherein the voltage feedback terminal is connected to the second end of the first voltage-dividing resistor.

8. The feedback circuit for a lamp load according to claim 7, wherein the non-dimming chip further comprises a first input terminal and a grounding terminal, wherein the first input terminal is connected to the power input terminal,
the drive circuit further comprises a first capacitor and a second capacitor, wherein the first capacitor is connected in parallel with the lamp load, and two ends of the second capacitor are respectively connected to the first input terminal and the grounding terminal.

9. A control circuit for a lamp load, comprising:
the feedback circuit for a lamp load according to claim 8, and
a drive circuit for a lamp load, the drive circuit being connected to the feedback circuit.
